(19) United States
(12) Patent Application Publication
(10) Pub. No.: US 2022/0113582 A1
(43) Pub. Date: Apr. 14, 2022

(54) COVER PLATE, COVER PLATE MANUFACTURING METHOD, AND DISPLAY DEVICE

(71) Applicant: WUHAN CHINA STAR OPTOELECTRONICS SEMICONDUCTOR DISPLAY TECHNOLOGY CO., LTD., Wuhan (CN)

(72) Inventors: Chunmei He, Wuhan (CN); Zhuo Zhang, Wuhan (CN)

(73) Assignee: WUHAN CHINA STAR OPTOELECTRONICS SEMICONDUCTOR DISPLAY TECHNOLOGY CO., LTD., Wuhan (CN)

(21) Appl. No.: 16/771,571

(22) PCT Filed: Apr. 9, 2020
(86) PCT No.: PCT/CN2020/083929

§ 371 Date: Jun. 10, 2020

(30) Foreign Application Priority Data
Mar. 25, 2020 (CN) 2020 10218608.7

(51) Int. Cl. G02F 1/1333; G02F 1/1335; G09F 9/30

(52) U.S. Cl. CPC G02F 1/133331; G09F 9/301; G02F 1/133512

(57) ABSTRACT

The present invention discloses a cover plate and a cover plate manufacturing method, and a display device. The cover plate includes: a first underlay substrate; a second underlay substrate disposed opposite to the first underlay substrate; and a light shielding structure disposed between the first underlay substrate and the second underlay substrate.

### FIELD OF INVENTION

The present invention relates to a field of display technologies, and specifically relates to a cover plate, a cover plate manufacturing method, and a display device.

### BACKGROUND OF INVENTION

In a modern society, display screens are widely used in various fields such as home appliances, mobile devices, and automobiles, and have progressively become an important part of industrialized equipment. Modern electronic devices usually require color consistency of the display region and the non-display region as possible when the display is off, that is, the display screen is evenly black.

To achieve the above objective, in the prior art, a black ink layer is printed in a non-display region on an outer circumference of a display screen, the black ink layer shields structures, and a full transmission glass is attached to the black ink layer. As such, when the display screen emits light, the black ink layer is not obvious to a user, when the display screen turns off, colors of the black ink layer and the display screen are consistent. The display screen with such structures can improve aesthetic characteristics of the device.

However, in the flexible display device, for achievement of a small folding radius, generally thicknesses of materials and a thickness of adhesive are reduced. However, the over thinned thickness of the adhesive results in a poor coverage rate of the ink. Therefore, a new technical solution guaranteeing the coverage rate of the ink while achieving a small folding radius is required.

### SUMMARY OF INVENTION

### Technical Issue

The present invention provides a cover plate and a cover plate manufacturing method, display device to solve the issue that in the conventional display device a thickness of a light shielding structure decreases after the light shielding structure is folded to result light leakage of the display device.

### Technical Solution

Technical solution to solve the above issues are as follows. The present invention provides a cover plate comprising: a first underlay substrate; a second underlay substrate disposed opposite to the first underlay substrate; and a light shielding structure disposed between the first underlay substrate and the second underlay substrate.

Furthermore, the first underlay substrate comprises: a first substrate; and a first flexible layer disposed on a side surface of the first substrate; and the second underlay substrate comprises: a second substrate disposed opposite to the first substrate; and a second flexible layer disposed on a side surface of the second substrate near the first substrate.

Furthermore, the first substrate and the second substrate are transparent material.

Furthermore, a thickness of the first underlay substrate is 30-60 microns.

Furthermore, a sum of the thickness of the first underlay substrate and a thickness of the second underlay substrate is 80 microns.

Furthermore, a side of the light shielding structure is attached to the first underlay substrate, and another side of the light shielding structure is attached to the second underlay substrate.

Furthermore, the light shielding structure is annular, and the light shielding structure is disposed opposite to an edge of a side surface of the second underlay substrate.

Furthermore, a material of the light shielding structure is black photoresist or ink.

Furthermore, a ratio of the thickness of the second underlay substrate to the thickness of the light shielding structure is 2:1-3:1.

The present invention also provides a cover plate manufacturing method, comprising providing a first substrate, coating polyimide solution on the first substrate, and curing the polyimide solution to form a first underlay substrate; manufacturing a light shielding structure on the first underlay substrate; coating polyimide solution on the light shielding structure, and curing the polyimide solution to form a second flexible layer on the light shielding structure; and coating a hard coating layer on the second flexible layer to form a second underlay substrate.

Furthermore, the step of manufacturing the light shielding structure specifically comprises: manufacturing a layer of black photoresist material on the first underlay substrate, and photoetching the black photoresist material to form the light shielding structure; or forming the light shielding structure on the first underlay substrate by a screen printing process.

The present invention also provides a display device comprising the cover plate.

Advantages

Advantages of the present invention are as follows. The present invention provides a cover plate for a display device and a cover plate manufacturing method that disposes the light shielding structure between two substrates to effectively reduce reduction of a thickness of the light shielding structure due to rub or folding, which prevent light leakage of the display device. The present invention by yellow light processes or screen printing processes manufactures a light shielding structure, which has a simple manufacturing method, is convenient for mass production and lowers a manufacturing cost.

### DESCRIPTION OF DRAWINGS

Specific embodiments of the present invention are described in details with accompanying drawings as follows to make technical solutions and advantages of the present invention clear.

FIG. 1 is a schematic view of a cover plate of an embodiment of the present invention.

FIG. 2 is a schematic view of a first underlay substrate of the embodiment of the present invention.

FIG. 3 is a schematic view of a semi product of a light shielding structure of the embodiment of the present invention.

FIG. 4 is a schematic view of a light shielding structure of the embodiment of the present invention.

FIG. 5 is a schematic view of a second underlay substrate of the embodiment of the present invention.

FIG. 6 is a schematic view of a display device of the embodiment of the present invention.

### REFERENCE CHARACTERS IN THE FIGURES

1 display device; 10 cover plate;
110 first underlay substrate; 120 second underlay substrate;
111 first underlay substrate; 112 first flexible layer;
121 second underlay substrate; 122 second flexible layer;
130 light shielding structure.

### DETAILED DESCRIPTION OF PREFERRED EMBODIMENTS

The technical solution in the embodiment of the present invention will be clearly and completely described below with reference to the accompanying drawings in the embodiments of the present invention. Apparently, the described embodiments are merely some embodiments of the present invention instead of all embodiments. According to the embodiments in the present invention, all other embodiments obtained by those skilled in the art without making any creative effort shall fall within the protection scope of the present invention.

In the description of the present invention, it should be understood that terminologies “center”, “longitudinal”, “transverse”, “length”, “width”, “thickness”, “upper”, “lower”, “front”, “rear”, “left”, “side”, “vertical”, “horizontal”, “top”, “bottom”, “inner”, “outer”, “clockwise”, “counterclockwise” for indicating relations of orientation or position are based on orientation or position of the accompanying drawings, are only for the purposes of facilitating description of the present invention and simplifying the description instead of indicating or implying that the referred device or element must have a specific orientation or position, must to be structured and operated with the specific orientation or position. Therefore, they should not be understood as limitations to the present invention. Furthermore, terminologies “first”, “second” are only for the purposes of description, and cannot be understood as indication or implication of comparative importance or a number of technical features. Therefore, a feature limited with “first”, “second” can expressly or implicitly include one or more features. In the description of the present invention, a meaning of “a plurality of” is two or more, unless there is a clear and specific limitation otherwise.

In the description of the present invention, it should be noted that unless clear rules and limitations otherwise exist, terminologies “install”, “connect”, “connection” should be understood in a broad sense. For instance, the connection can be a fixed connection, a detachable connection or an integral connection. The connection can be a mechanical connection, an electrical connection or a telecommunication. The connection can be a direct connection, an indirect connection through an intermedium, can be an internal communication between two elements or an interaction between the two elements. For a person of ordinary skill in the art, the specific meaning of the above terminology in the present invention can be understood on a case-by-case basis.

In the present invention, it should be noted that unless clear rules and limitations otherwise exist, words “a first feature is “on” or “under” a second feature” can include a direct contact of the first and second features, can also include a contact of the first and second features through another feature therebetween instead of a direct contact. Furthermore, words “the first feature is “above” or “over” the second feature include that the first feature is right above or obliquely above the second feature, or only indicate that a level of the first feature is higher that of the second feature. Words “the first feature is “under” or “below” the second feature include that the first feature is right under or obliquely under the second feature, or only indicate that the level of the first feature is lower than that of the second feature.

The following disclosure provides many different embodiments or examples to achieve different structures of the present invention. To simplify the disclosure of the present invention, the components and arrangements of the specific examples are described below. Of course, they are merely examples, and the purpose is not to limit the present invention. Furthermore, the present invention may repeat reference numerals and/or reference letters in different examples. The repetition is for the purpose of simplification and clarity, and does not by itself indicate the relationship between the various embodiments and/or settings discussed. In addition, the present invention provides examples of various specific processes and materials, but a person of ordinary skill in the art can be aware of the application of other processes and/or the use of other materials.

### EMBODIMENT

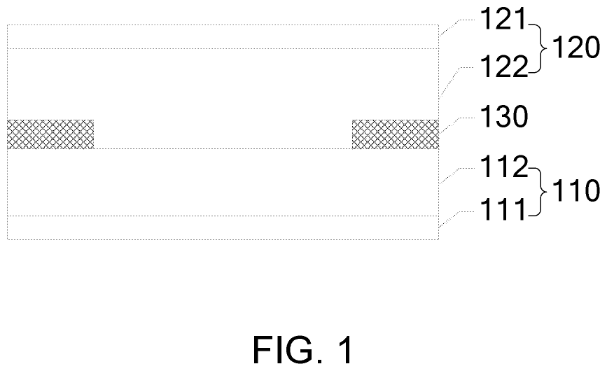

With reference to FIG. 1, FIG. 1 is a schematic view of a cover plate of an embodiment of the present invention. In the present embodiment, the cover plate 10 of the present invention comprises a first underlay substrate 110, a second underlay substrate 120 and a light shielding structure 130.

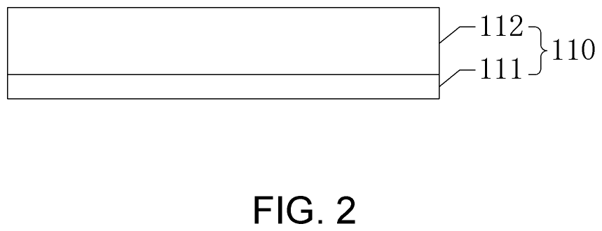

With reference to FIG. 2, FIG. 2 is a schematic view of a first underlay substrate of the embodiment of the present invention. A thickness of the first underlay substrate 110 is 30-60 microns. The first underlay substrate 110 comprises a first substrate 111 and a first flexible layer 112. The first substrate 111 is hard transparent glass substrate, and a material of the first substrate 111 comprises at least one of silicon oxide, boron oxide and aluminum oxide. The first substrate 111 comprises higher external mass and internal strength, and has a smooth surface to entirely transmit the light.

The first flexible layer 112 is disposed on the first substrate 111, and a material thereof is polyimide resin or denatured polyimide resin, polyimide resin, or denatured polyimide resin, which is one of organic materials with best comprehensive performance and has a high temperature resistance over 400° C. For long-term use, it is workable within a range of a temperature of 200-300° C. is an excellent flexible material.

The light shielding structure 130 is disposed on a surface of a side of the first flexible layer 112 away from the first substrate 111, the light shielding structure 130 has an annular shape with a width of about 6-8 μm. The light shielding structure 130 employs an ink material and has an excellent light shielding effect. A portion covered by the light shielding structure is a non-display region, which not only guarantees normal light emission of the displaying region but also prevent light leakage of the non-display region to enhance display effect of the display device.

A thickness of the second underlay substrate 120 is 30-60 microns. The second underlay substrate 120 comprises a second substrate 121 and a second flexible layer 122. The second flexible layer 122 is disposed above the light shielding structure 130. Because a thickness of the light shielding structure 130 is thin, in the present embodiment, when the second flexible layer 122 is filled in gaps of the light shielding structure 130 when coated on the light shielding structure 130, which guarantees no gaps formed between the light shielding structure 130 and the second flexible layer 122 and prevent invasion of external water vapor. A material of the second flexible layer 122c1 is polyimide resin or denatured polyimide resin, polyimide resin, or denatured polyimide resin, which is one of organic materials with best comprehensive performance and has a high temperature resistance over 400° C. For long-term use, it is workable within a range of a temperature of 200-300° C. is an excellent flexible material.

The second substrate 121 is a hard coating layer and is made by coating a wear-resistant thin layer such as TiC or TiN, HfN, aluminum oxide on a surface of the second flexible layer 122 to form a surface coating hard alloy through chemical vapor deposition (CVD) process. The second substrate 121 has excellent wear-resistant ability and pressure-resistant ability and can effectively block external impurities, water vapor from invading the display device and causing abnormal display.

For better explanation of the present invention, in the present embodiment, a cover plate manufacturing method is further provided and has specific steps S1-S5 as follows.

The step S1 comprises providing a first substrate, coating polyimide solution on the first substrate, and curing the polyimide solution to form a first underlay substrate.

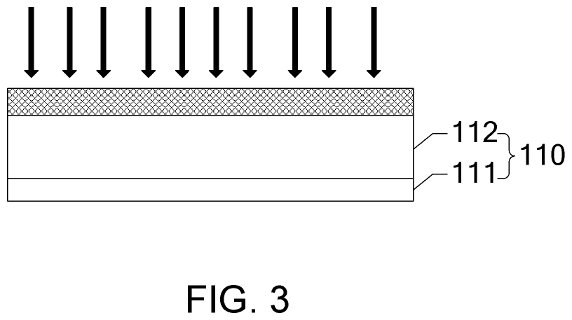

The step S2 comprises manufacturing a layer of black photoresist material on the first underlay substrate, with reference to FIG. 3, FIG. 3 is a schematic view of a semi product of a light shielding structure of the embodiment of the present invention.

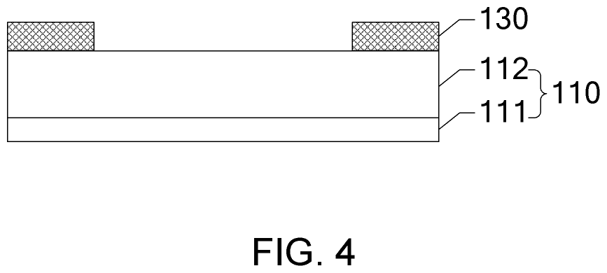

The step S3 comprises photoetching the black photoresist material to form the light shielding structure, with reference to FIG. 4, FIG. 4 is a schematic view of a light shielding structure of the embodiment of the present invention.

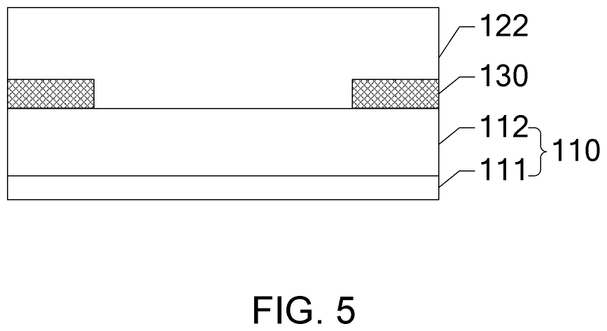

The step S4 comprises coating polyimide solution on the light shielding structure, and curing the polyimide solution to form a second flexible layer on the light shielding structure, with reference to FIG. 5, FIG. 5 is a schematic view of a second underlay substrate of the embodiment of the present invention.

The step S5 comprises coating a hard coating layer on the second flexible layer to form a second underlay substrate.

In another preferred embodiment of the present invention, a cover plate manufacturing method is further provided and comprises steps S11-S14 as follows.

The step S11 comprises providing a first substrate, coating polyimide solution on the first substrate, and curing the polyimide solution to form a first underlay substrate.

The step S12 comprises manufacturing a light shielding structure on the first underlay substrate by a screen printing process.

The step S13 comprises coating a hard coating layer on the second flexible layer to form a second underlay substrate.

The step S14 comprises coating polyimide solution on the light shielding structure, and curing the polyimide solution to form the second flexible layer on the light shielding structure;

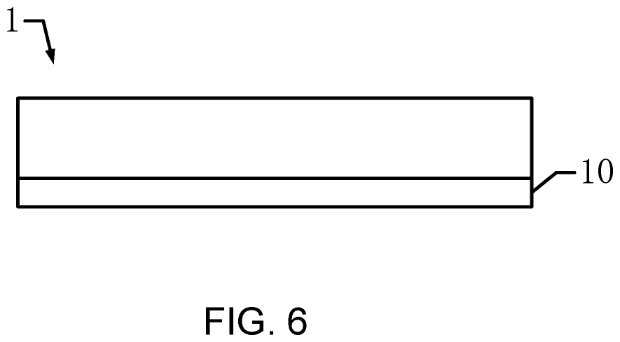

With reference to FIG. 6, FIG. 6 is a schematic view of a display device of the embodiment of the present invention. In the present embodiment, a display device 1 of the present invention comprises a cover plate 10, wherein main technical characteristics and technical solutions of the display device 1 are primarily embodied on the cover plate 10, other components of the display device 1 will not be repeatedly described in detail.

Advantages of the present invention are as follows. The cover plate and the cover plate manufacturing method of the present invention dispose the light shielding structure between two substrates to effectively reduce reduction of a thickness of the light shielding structure due to rub or folding, which prevent light leakage of the display device. The present invention by yellow light processes or screen printing processes manufactures a light shielding structure, which has a simple manufacturing method, is convenient for mass production and lowers a manufacturing cost.

The description of the above embodiments is only for assisting understanding of the technical solutions of the present application and the core ideas thereof. Those of ordinary skill in the art should understand that they can still modify the technical solutions described in the foregoing embodiments are or equivalently replace some of the technical features. These modifications or replacements do not depart from the essence of the technical solutions of the embodiments of the present application.

What is claimed is:

1. A cover plate, comprising:
a first underlay substrate;
a second underlay substrate disposed opposite to the first underlay substrate; and
a light shielding structure disposed between the first underlay substrate and the second underlay substrate.

2. The cover plate as claimed in claim 1, wherein
the first underlay substrate comprises
a first substrate; and
a first flexible layer disposed on a side surface of the first substrate; and
the second underlay substrate comprises
a second substrate disposed opposite to the first substrate; and
a second flexible layer disposed on a side surface of the second substrate near the first substrate.

3. The cover plate as claimed in claim 2, wherein
a thickness of the first underlay substrate is 30-60 microns; and/or
a sum of the thickness of the first underlay substrate and a thickness of the second underlay substrate is 80 microns.

4. The cover plate as claimed in claim 3, wherein
a ratio of the thickness of the first underlay substrate to a thickness of the light shielding structure is 2-3.

5. The cover plate as claimed in claim 1, wherein
a side of the light shielding structure is attached to the first underlay substrate, and another side of the light shielding structure is attached to the second underlay substrate.

6. The cover plate as claimed in claim 2, wherein
the light shielding structure comprises an annular shape, and the second flexible layer is filled in the annular shape.

7. The cover plate as claimed in claim 1, wherein
a material of the light shielding structure is black photoresist or ink.

8. A cover plate manufacturing method, comprising steps as follows:
providing a first substrate, coating polyimide solution on the first substrate, and curing the polyimide solution to form a first underlay substrate;
manufacturing a light shielding structure on the first underlay substrate;
coating polyimide solution on the light shielding structure, and curing the polyimide solution to form a second flexible layer on the light shielding structure; and
coating a hard coating layer on the second flexible layer to form a second underlay substrate.

9. The cover plate manufacturing method as claimed in claim 8, wherein the step of manufacturing the light shielding structure specifically comprises:
manufacturing a layer of black photoresist material on the first underlay substrate, and photoetching the black photoresist material to form the light shielding structure; or
forming the light shielding structure on the first underlay substrate by a screen printing process.

10. A display device, comprising the cover plate as claimed in claim 1.
